(19) United States
(12) Patent Application Publication
(10) Pub. No.: US 2013/0132772 A1
(43) Pub. Date: May 23, 2013

(54) EMBEDDED MEMORY WITH SYSTEM REPAIR DATA AND SYSTEM REPAIR METHOD THEREFOR

(71) Applicant: Shuang LI, Shenzhen (CN)

(72) Inventor: Shuang LI, Shenzhen (CN)

(73) Assignee: SILICON MOTION, INC., Jhubei City (TW)

(21) Appl. No.: 13/425,343

(22) Filed: Mar. 20, 2012

(30) Foreign Application Priority Data
Nov. 17, 2011 (CN) 201110379360.3

(51) Int. Cl. G06F 11/14

(52) U.S. Cl. 714/15; 714/E11.118

(57) ABSTRACT

An embedded memory with system repair data is provided. The embedded memory includes a flash memory unit, a storage unit, and a control unit. The flash memory unit stores an in-system programming (ISP) code. The storage unit stores a system repair code. The system repair code is used for rebuilding the ISP code. The control unit is electrically connected to the flash memory unit and the storage unit. The control unit determines whether the ISP code has been broken and reads the system repair code to rebuild the ISP code when the ISP code has been broken. A system repair method for the embedded memory is also provided, which comprises the steps of determining that the ISP code stored in the flash memory unit has been broken, reading the system repair code stored in the memory unit, and rebuilding the ISP code according to the system repair code.

### CROSS REFERENCE TO RELATED APPLICATIONS

This Application claims priority of China Patent Application No. 201110379360.3, filed on Nov. 17, 2011, the entirety of which is incorporated by reference herein.

### BACKGROUND OF THE INVENTION

1. Field of the Invention

The invention relates to a flash memory technique, and more particularly to an embedded memory and a repair method therefor.

2. Description of the Related Art

Flash memories, being one type of non-volatile memory, uses a floating gate transistor to control the amount of charges flowing into the flash memories for data storage. Flash memories do not require extra power to maintain stored data. In other words, when external power source is switched off, the data stored in the flash memories is not lost.

Flash memories may be categorized into two types: NOR flash memories and NAND flash memories. Generally, NOR flash memories are used to store program codes, and the NAND flash memories are used to store data. Based on the amount of data which each transistor cell can store, NAND flash memories may be categorized into two types: a single level cell structure and a multi level cell structure.

A typical structure of flash memories has been disclosed in U.S. Patent Application Publication 2007/0234341 A1. The main devices in the structure comprise a computer device, a reading device, and a memory card. The memory card comprises a memory and a controller. The firmware of the memory card is stored in the controller and used to guide the controller to work.

The above U.S. Patent Application Publication discloses a technique of updating firmware of the memory card through the internet. In the past, since manufacturers of memory cards may issue new firmware versions with technical improvements, users do not update the firmware by themselves and have to send memory cards to the manufactures to update the firmware. The above U.S. Patent Application Publication discloses an in-system programming code mechanism. The memory card uses the in-system programming code mechanism to receive new firmware versions from manufacturers through the internet and update the firmware. However, there is a drawback where the memory card has to receive new firmware versions through the internet and then update the firmware. In other words, if the computer device is not activated and does not connect to the internet, the memory card does not update the firmware with the new firmware version.

For embedded memories, memory cards may not update firmware with new firmware versions easily because computer devices are not activated and do not connect to the internet. Embedded memories are mainly applied to hand-held electronic apparatuses to serve as storage units. Compared with conventional storage units, embedded memories have three different features. The first feature is that if firmware of embedded memories has been broken, hand-held electronic apparatuses may not work normally and connect to the internet to update the firmware, so that the hand-held electronic apparatuses are not activated. The second feature is that since embedded memories are bonded on the hand-held electronic apparatuses by tin balls and tin stoves, the firmware of the embedded memories may be broken during the bonding process using the tin stoves. The third feature is that since the embedded memories are embedded in the hand-held electronic apparatuses, the cost and time do not match economic benefits when the original embedded memories are taken out and replaced with new memories.

As the above describes, for various applications, embedded memories are bonded on electronic apparatuses by using tin stoves, and the operating temperature of the tin stoves is usually higher than 250 degrees. The high operating temperature may raise the risk of breaking data stored in flash memory units. Accordingly, how to ensure security of in-system programming (ISP) codes of embedded memories during the bonding process performed by using a tin stove to overcome the above drawbacks where hand-held electronic apparatuses are not activated is an important issue.

### BRIEF SUMMARY OF THE INVENTION

An exemplary embodiment of an embedded memory with system repair data is provided. The embedded memory with system repair data comprises a flash memory unit, a storage unit, and a control unit. The flash memory unit stores an in-system programming (ISP) code. The storage unit stores a system repair code. The system repair code is used for rebuilding the ISP code. The control unit is electrically connected to the flash memory unit and the storage unit. The control unit determines whether the ISP code has been broken and reads the system repair code to rebuild the ISP code when the ISP code has been broken.

In another embodiment, the storage unit may be implemented by a one time programmable ROM (OTP ROM) or an erasable programmable ROM (EPROM). Compared with the flash memory unit, since an OTP ROM or EPROM has better data maintainability, the stored data is not easily lost due to environment temperature variations, such as excessive low temperatures or excessive high temperatures.

In further another embodiment, when the ISP code has been broken, the control unit reads the system repair code. The system repair code guides the control unit to format the flash memory, discriminate broken areas from unbroken areas in the flash memory unit, and then rebuild the ISP code in the unbroken areas in the flash memory unit, thereby achieving system repair operation.

In also another embodiment, the embedded memory with system repair data further comprises a host electrically connected to the control unit. When the ISP code has been broken, the control unit reads the system repair code. The embedded memory with system repair data comprises guiding the control unit to send a busy command to the host, so that the host waits for a system rebuilding operation of the embedded memory, thereby preventing the interference between the control unit and the host.

An exemplary embodiment of a system repair method for an embedded memory is provided. The system repair method comprises the steps of determining that an in-system programming (ISP) code stored in a flash memory unit has been broken, reading a system repair code stored in a memory unit, and rebuilding the ISP code according to the system repair code.

Another exemplary embodiment of a system repair method for an embedded memory is provided. The system repair method comprises the steps of determining that an ISP code stored in a flash memory unit has been broken, reading a system repair code stored in a storage unit, formatting the flash memory unit, discriminating broken areas from unbroken areas in the flash memory unit, and rebuilding the ISP code in the unbroken areas according to the system repair code.

Further, another exemplary embodiment of a system repair method for an embedded memory is provided. The system repair method comprises the steps of determining that an ISP code stored in a flash memory unit has been broken, sending a busy command to a host, reading a system repair code stored in a storage unit, and rebuilding the ISP code according to the system repair code.

According to the embedded memory and the repair method therefor, a storage unit with better data maintainability is used to store a system repair code. When an ISP code has been broken, the ISP code can be rebuilt according to the system repair code, thereby solving the problem for which a hand-held electronic apparatus is unable to be activated due to the ISP code being broken during the bonding process using tin stoves.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B show exemplary embodiments of an embedded memory with system repair data;

FIGS. 2A and 2B show other exemplary embodiments of an embedded memory with system repair data;

FIG. 3 is a flow chart of an exemplary embodiment of a system repair method for an embedded memory;

FIG. 4 is a flow chart of another exemplary embodiment of a system repair method for an embedded memory; and

FIG. 5 is a flow chart of further another exemplary embodiment of a system repair method for an embedded memory.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Certain terms are used throughout the following description and claims, which refer to particular components. As one skilled in the art will appreciate, manufacturers may refer to a component by different names. The following description and claims do not intend to distinguish between components that differ in name but not in function. In the following description and in the claims, the terms “include” and “comprise” are used in an open-ended fashion, and thus should be interpreted to mean “include, but not limited to . . . . ” Also, the term “couple” is intended to mean either an indirect or direct electrical connection. Accordingly, if one device is coupled to another device, that connection may be through a direct connection (including electrical connection, wireless transmission, optical, and other signal connections), or through an indirect electrical connection via other devices and connections.

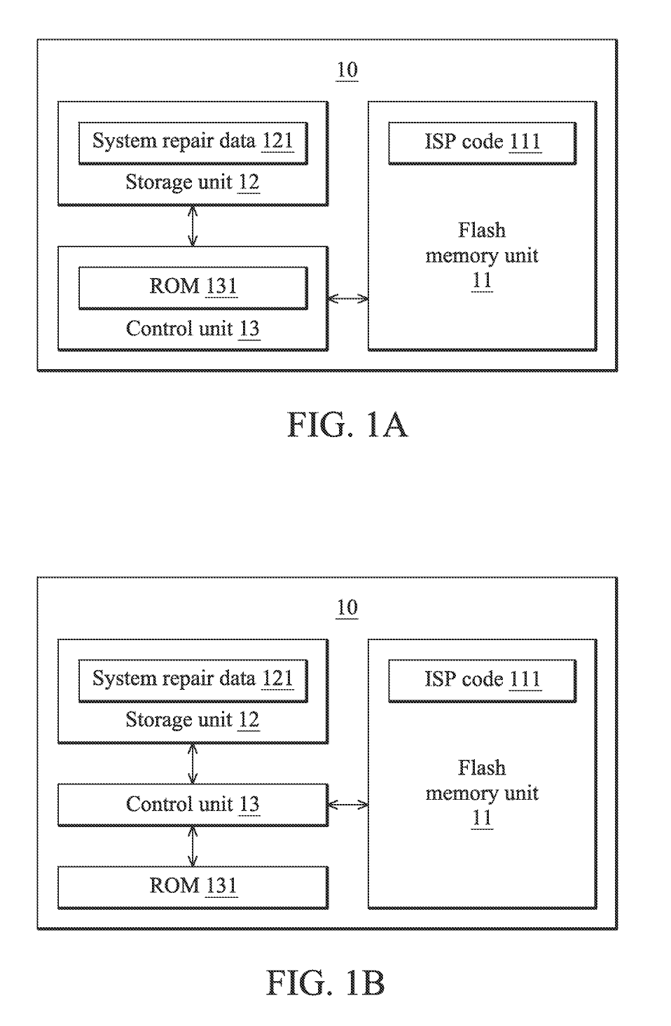

FIGS. 1A and 1B show exemplary embodiments of an embedded memory with system repair data. Referring to FIG. 1A, an embedded memory 10 with system repair data comprises a flash memory unit 11, a storage unit 12, and a control unit 13. The flash memory unit 11 stores an in-system programming (ISP) code 111, and the storage unit 12 stores a system repair data 121. The system repair code 121 is used to rebuild the ISP code 111. The control unit 13 is electrically connected to the flash memory unit 11 and the storage unit 12.

The control unit 13 has a function of determining whether the ISP code 111 has been broken. In general, the control unit 13 comprises a read-only memory (ROM) 131 which stores a ROM code. The ROM code can guide the control unit 13 to work. For example, the control unit 13 reads the ROM code, reads the ISP code 111 according to the information of the ROM code, and determines whether the ISP code 11 has been broken. When the control unit 13 determines that the ISP code 11 has been broken, the control unit 13 reads the system repair code 121 according to the ROM code to rebuild the ISP code 111. Also referring to FIG. 1B, the difference between FIGS. 1A and 1B is that, in the embodiment of FIG. 1B, the ROM 131 is disposed at the outside of the control unit 13, and the ROM 131 and the control unit 13 are electrically connected to each other.

The embedded memory 10 with system repair data may be bonded on a hand-held electronic apparatus through a bonding process performed by a tin stove. The high temperature of the tin stove may break the transistor structure of the flash memory unit 11. Thus, when the control unit 13 determines that the ISP code 111 has been broken, the control unit 13 requires formatting the flash memory unit 11 to re-discriminate broken areas from unbroken areas in the flash memory unit 11. After the control unit 13 discriminates the broken areas, the control unit 113 rebuilds the ISP code 11 in the unbroken areas in the flash memory unit 11, thereby achieving system repair operation. Thus, the area in the flash memory unit 11 where the rebuilt ISP code is stored is different from the area in the flash memory unit 11 where the ISP code is stored before the rebuilding. Moreover, the content of the rebuilt ISP code is not requested to be the same as the content of the ISP code before the rebuilding.

In the above embodiments, the storage unit 121 may be implemented by a one time programmable ROM (OTP ROM) or an erasable programmable ROM (EPROM). Compared with the flash memory unit 11, since an OTP ROM or EPROM has better data maintainability, the stored data is not easily lost due to environment temperature variations, such as excessive low temperatures or excessive high temperatures.

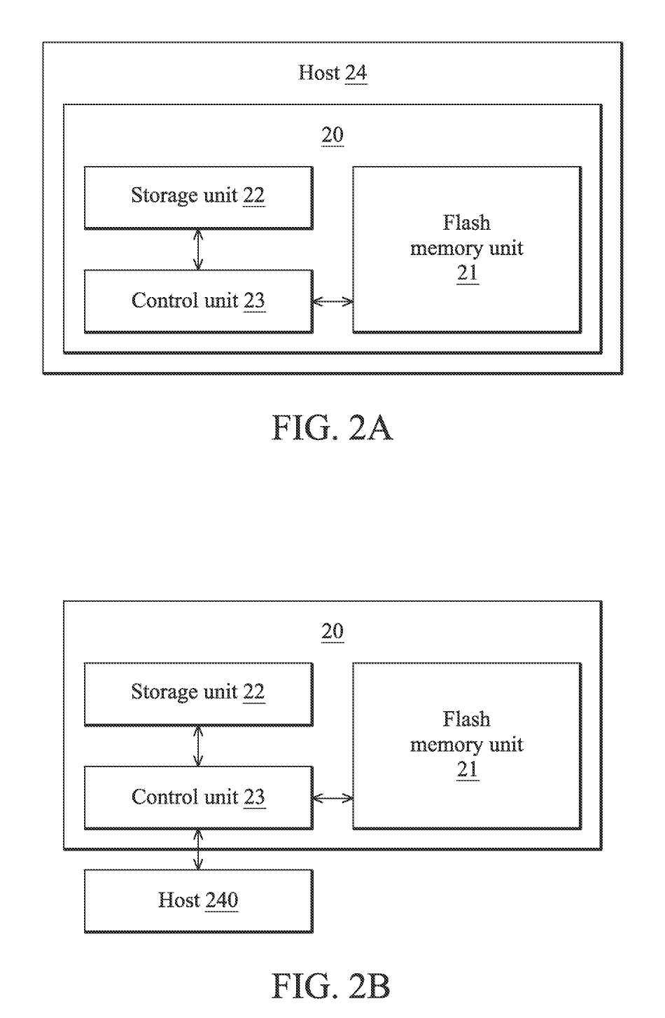

FIGS. 2A and 2B show other exemplary embodiments of an embedded memory with system repair data. Referring to FIG. 2A, an embedded memory 20 with system repair data comprises a flash memory unit 21, a storage unit 22, and a control unit 23. The embedded memory 20 is disposed in a host 24, such as a hand-held electronic apparatus. The control unit 23 of the embedded memory 20 is electrically connected to the host 24. When the control unit 23 determines that an ISP code (not shown) has been broken, the control unit 23 sends a busy command to the host 24, so that the host 24 waits for a system rebuilding operation of the embedded memory 20, thereby preventing the interference between the control unit 23 and the host 24. Also referring to FIG. 2B, the difference between FIGS. 2A and 2B is that, in the embodiment of FIG. 2B, the control unit 23 is electrically connected to an external host 240.

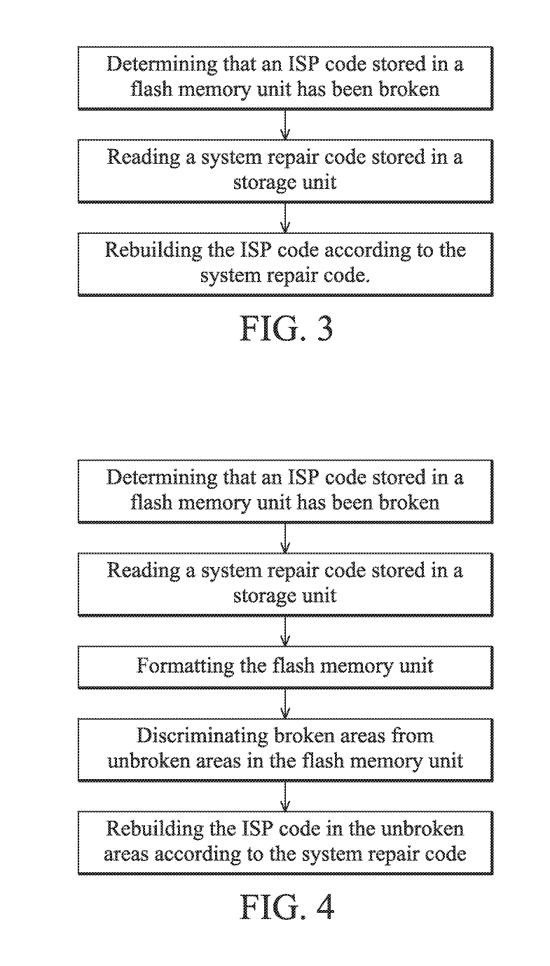

FIG. 3 is a flow chart of an exemplary embodiment of a system repair method for an embedded memory. Referring to FIG. 3, a system repair method for an embedded memory comprises the steps of determining that an ISP code stored in a flash memory unit has been broken, reading a system repair code stored in a storage unit, and rebuilding the ISP code according to the system repair code. In the embodiment, the storage unit may be implemented by a one time programmable ROM (OTP ROM) or an erasable programmable ROM (EPROM). Compared with the flash memory unit, since an OTP ROM or EPROM has better data maintainability, the stored data is not easily lost due to environment temperature variations, such as excessive low temperatures or excessive high temperatures.

FIG. 4 is a flow chart of another exemplary embodiment of a system repair method for an embedded memory. Referring to FIG. 4, a system repair method for an embedded memory comprises the steps of determining that an ISP code stored in a flash memory unit has been broken, reading a system repair code stored in a storage unit, formatting the flash memory unit, discriminating broken areas from unbroken areas in the flash memory unit, and rebuilding the ISP code in the unbroken areas according to the system repair code.

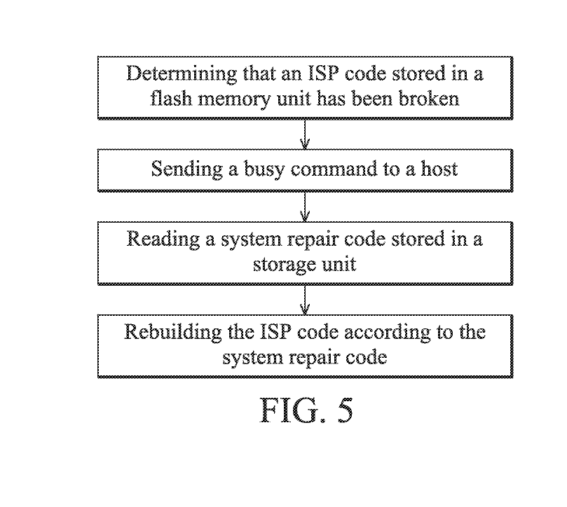

FIG. 5 is a flow chart of further another exemplary embodiment of a system repair method for an embedded memory. Referring to FIG. 5, a system repair method for an embedded memory comprises the steps of determining that an ISP code stored in a flash memory unit has been broken, sending a busy command to a host, reading a system repair code stored in a storage unit, and rebuilding the ISP code according to the system repair code.

According to the embedded memory and the repair method therefor, a storage unit with better data maintainability is used to store a system repair code. When an ISP code has been broken, the ISP code can be rebuilt according to the system repair code, thereby solving the problem of that a hand-held electronic apparatus is unable to be activated due to the ISP code being broken during the bonding process using tin stoves.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An embedded memory with system repair data comprising:
a flash memory unit storing an in-system programming (ISP) code;
a storage unit storing a system repair code, wherein the system repair code is used for rebuilding the ISP code; and
a control unit, electrically connected to the flash memory unit and the storage unit, determining whether the ISP code has been broken and reading the system repair code to rebuild the ISP code when the ISP code has been broken.

2. The embedded memory with system repair data as claimed in claim 1, wherein the storage unit is implemented by a one time programmable ROM (OTP ROM).

3. The embedded memory with system repair data as claimed in claim 1, wherein the storage unit may be implemented by an erasable programmable ROM (EPROM).

4. The embedded memory with system repair data as claimed in claim 1, wherein the system repair code is further used for formatting the flash memory unit.

5. The embedded memory with system repair data as claimed in claim 4, wherein the system repair code is further used for discriminating broken areas in the flash memory unit.

6. The embedded memory with system repair data as claimed in claim 1, wherein the control unit is electrically connected to a host.

7. The embedded memory with system repair data as claimed in claim 6, wherein when the ISP code has been broken, the control unit sends a busy command to the host.

8. A system repair method for an embedded memory, the embedded memory comprising a flash memory unit, a storage unit, and a control unit, and the system repair method comprising:
determining that an in-system programming (ISP) code stored in the flash memory unit has been broken;
reading a system repair code stored in the memory unit; and
rebuilding the ISP code according to the system repair code.

9. The system repair method as claimed in claim 8, wherein after the step of reading the system repair code stored in the memory unit, the system repair method further comprises:
formatting the flash memory unit by the control unit.

10. The system repair method as claimed in claim 9, wherein after the step of formatting the flash memory unit by the control unit, the system repair method further comprises:
discriminating broken areas in the flash memory unit by the control unit.

11. The system repair method as claimed in claim 8, wherein the control unit is electrically connected to a host, and after the step of determining the ISP code stored in the flash memory unit has been broken, the system repair method further comprises:
sending a busy command to the host.

12. The system repair method as claimed in claim 8, wherein the storage unit is implemented by a one time programmable ROM (OTP ROM).

13. The system repair method as claimed in claim 1, wherein the storage unit may be implemented by an erasable programmable ROM (EPROM).
